(19) United States
(12) Patent Application Publication
(10) Pub. No.: US 2026/0078542 A1
(43) Pub. Date: Mar. 19, 2026

(54) ELECTRONIC DEVICE

(71) Applicant: SAMSUNG ELECTRONICS CO., LTD., Suwon-si (KR)

(72) Inventors: Kidu KIM, Suwon-si (KR); Youngeun KIM, Suwon-si (KR); Changhyun PARK, Suwon-si (KR)

(73) Assignee: SAMSUNG ELECTRONICS CO., LTD., Suwon-si (KR)

(21) Appl. No.: 19/397,030

(22) Filed: Nov. 21, 2025

Related U.S. Application Data
(63) Continuation of application No. PCT/KR2024/003198, filed on Mar. 13, 2024.

(30) Foreign Application Priority Data
Jun. 8, 2023 (KR) 10-2023-0073735

(51) Int. Cl. D06F 34/32; G06F 3/041; G06F 3/044; G02F 1/1333

(52) U.S. Cl. CPC D06F 34/32; G06F 3/0412; G06F 3/0443; G02F 1/13338

(57) ABSTRACT

An electronic device include a touch screen panel and a housing including an opening formed in a front surface, through which a portion of the touch screen panel is exposed, and the touch screen panel may include a first tempered glass insertable into the opening, a touch panel, configured to receive a touch input, including a touch area and a wiring area, a second tempered glass including a first support area located between the touch area and the first tempered glass, and second support area located between the housing and the wiring area, and a glass protection member having at least a portion between the housing and the second support area and including a material different from the second tempered glass.

### CROSS-REFERENCE TO RELATED APPLICATION

This application is a continuation application, under 35 U.S.C. §111(a), of international application No. PCT/KR2024/003198, filed March 13, 2024, which claims priority under 35 U. S. C. §119 to Korean Patent Application No. 10-2023-0073735, filed June 8, 2023, the disclosures of which are incorporated herein by reference in their entireties.

### TECHNICAL FIELD

Embodiments provide an electronic device.

### BACKGROUND ART

Electronic devices, for example, household appliances such as washing machines and refrigerators, may have various outer appearances. For example, an electronic device may include a housing that forms an outer appearance and a touch screen panel capable of touch input and of outputting a screen to the outside through an opening formed in the housing.

Electronic devices including such touch screen panels may have different outer appearance aesthetics depending on the material of the housing as well as the arrangement structure of the touch screen panel.

### Disclosure of Invention

### Solution to Problem

An electronic device according to an embodiment may include a touch screen panel and a housing that forms an outer appearance and has an opening on a front surface, through which a portion of the touch screen panel is exposed.

The touch screen panel may include a first tempered glass insertable into the opening, a touch panel, configured to receive a touch input, including a touch area located at a rear side of the first tempered glass, exposed to a front side of the first tempered glass through the opening while thefirst tempered glass is inserted into the opening, and a wiring area located at a rear side of the housing and surrounding the touch area, and a display panel located at a rear side of the touch panel.

The touch screen panel may further include a second tempered glass including a first support area located between the touch area and the first tempered glass and supporting the touch area, and a second support area located between the housing and the wiring area and supporting the wiring area.

The touch screen panel may further include a glass protection member having at least a portion located between the housing and the second support area and including a material different from the second tempered glass.

### BRIEF DESCRIPTION OF DRAWINGS

FIG. 1 is a perspective view showing an electronic device according to an embodiment.

FIG. 2 is a diagram showing an example of a side surface of the electronic device of FIG. 1 according to an embodiment.

FIG. 3 is an assembled perspective view showing an example in which a touch screen panel is located in a housing in an electronic device, according to an embodiment.

FIG. 4 is an exploded perspective view showing the touch screen panel of FIG. 3 in an exploded state according to an embodiment.

FIG. 5 is a schematic diagram of a touch panel of a touch screen panel, according to an embodiment.

FIG. 6 is a cross-sectional view showing a state in which a touch screen panel is located in a housing, according to an embodiment.

FIG. 7 is an enlarged cross-sectional view of a portion of the touch screen panel of FIG. 6 according to an embodiment.

FIGS. 8A and 8B are diagrams for explaining a process of fixing a touch screen panel to a housing, according to an embodiment.

FIG. 9 is a cross-sectional view showing another example of a housing and a touch screen panel in an electronic device, according to an embodiment.

FIG. 10 is a cross-sectional view showing another example of a housing and a touch screen panel in an electronic device, according to an embodiment.

FIG. 11 is a diagram for explaining an example of an electronic device according to an embodiment.

FIG. 12 is a diagram for explaining a touch screen panel installed on a door of an electronic device, according to an embodiment.

FIG. 13 illustrates a structure in which a touch screen panel is located in a housing, according to an embodiment.

FIG. 14 is an enlarged view of a portion of the touch screen panel and housing of FIG. 13 according to an embodiment.

### MODE FOR THE INVENTION

Hereinafter, exemplary embodiments according to the present disclosure will be described in detail with reference to the contents described in the attached drawings. The same reference numbers or symbols presented in each drawing represent parts or components that perform substantially the same function.

Terms that include ordinal numbers, such as "first" and "second" may be used to describe various components, but the components are not limited by the terms. The terms are only used to distinguish one component from another component. For example, without departing from the scope of the present disclosure, the first component may be named the second component, and similarly, the second component may also be named the first component. The term “and/or” includes any combination of multiple related items or any single item from among multiple related items.

The terms used in the present specification are used to describe embodiments and are not intended to limit and/or restrict the present disclosure. Singular expressions include plural expressions unless the context clearly indicates otherwise. In the present specification, it should be understood that terms such as "comprise (include)" or "have" are intended to specify the presence of a feature, number, step, operation, component, part or combination thereof described in the present specification, but do not exclude in advance the possibility of the presence or addition of one or more other features, numbers, steps, operations, components, parts or combinations thereof. The same reference numerals in each drawing represent elements that perform substantially the same function.

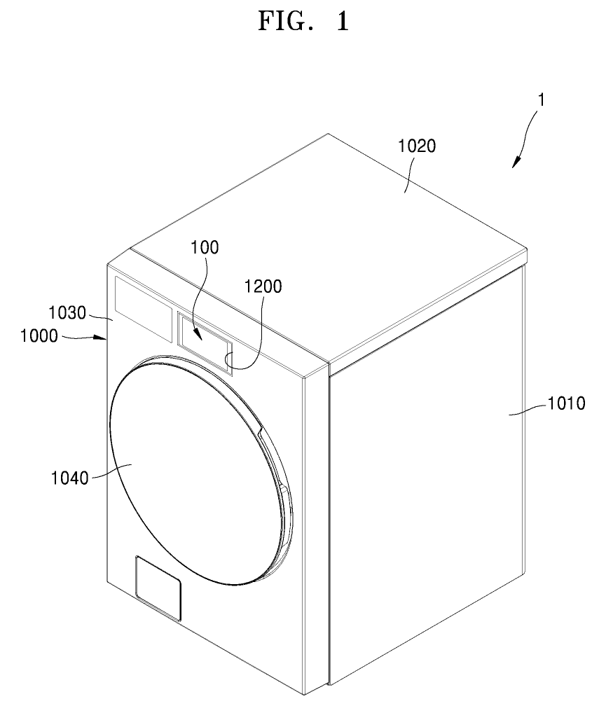

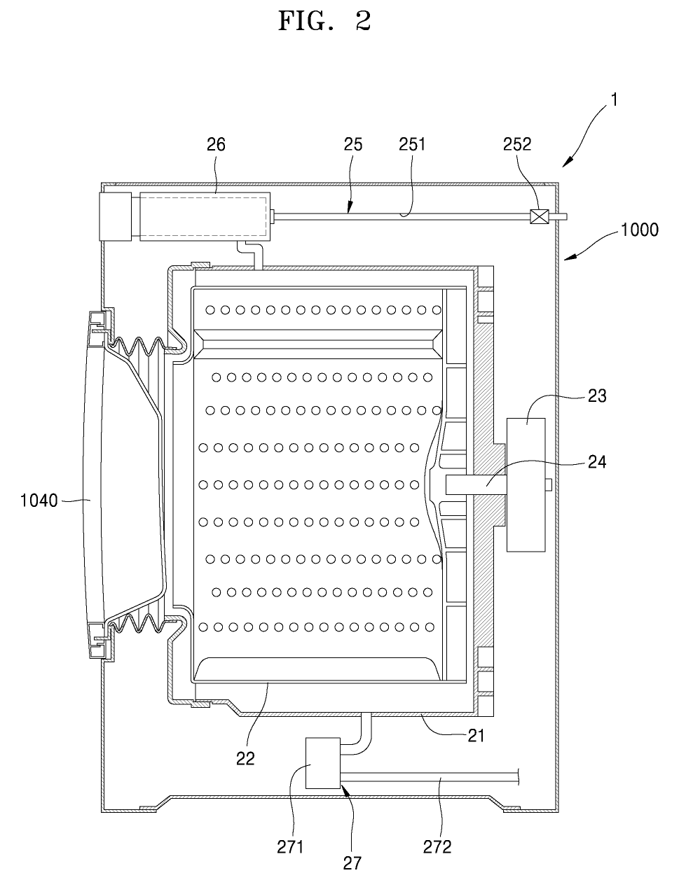

FIG. 1 is a perspective view showing an electronic device 1 according to an embodiment, and FIG. 2 is a diagram showing an example of a side surface of the electronic device 1 of FIG. 1.

Referring to FIGS. 1 and 2, the electronic device 1 according to an embodiment may include a housing 1000 and a touch screen panel 100 as components that form an outer appearance. The electronic device 1 according to an embodiment may be a laundry treatment device, for example, a washing machine. In the embodiments of FIGS. 1 and 2, a washing machine is exemplified as an example of an electronic device 1, and a structure in which the touch screen panel 100 is located at an upper side of a front side of the electronic device 1 is exemplified, but the present disclosure is not necessarily limited thereto, and the type of the electronic device 1 and the position of the touch screen panel 100 may be changed.

The housing 1000 may form the outer appearance of the electronic device 1 and include an inlet for loading and unloading laundry. A door 1040 may open and close the inlet.

The electronic device 1 may include a tub 21, a drum 22, a motor 23, a water supply device 25, a detergent container 26, and a drainage device 27 that are arranged inside the housing 1000.

The tub 21 is fixedly installed inside the housing 1000 and receives washing water supplied from the water supply device 25. The motor 23 for rotating the drum 22 may be mounted at an outer side of the tub 21.

The drum 22 has a shape corresponding to the shape of the tub 21 and is located inside the tub 21. A rotation shaft 24 may be mounted at an outer side of the drum 22, and the rotation shaft 24 may extend out of the tub 21 and may be connected to the motor 23. The motor 23 may transmit rotational power to the drum 22 to rotate the drum 22. The drum 22 may be rotated clockwise or counterclockwise inside the tub 21 depending on a rotation direction of the motor 23.

A laundry inlet connected to the inlet may be provided on one surface of the drum 22 and a plurality of holes may be provided on the other surfaces. Washing water may be introduced or discharged through the plurality of holes.

The water supply device 25 may be connected to the tub 21 to supply washing water into the tub 21. For example, the water supply device 25 may include a water supply pipe 251 and a water supply valve 252. The water supply pipe 251 may be connected between the detergent container 26 and the tub 21. Water and detergent in the detergent container 26 may move into the tub 21 through the water supply pipe 251.

The drainage device 27 may be connected to the tub 21 to drain washing water inside the tub. For example, the drainage device 27 may include a pump 271 and a drain pipe 272. The pump 271 may pump water inside the tub 21 and the drum 22 during a drainage and dehydration cycle, and the drain pipe 272 may be provided at a lower side of the tub 21 and may discharge washing water to the outside.

The housing 1000 may include a plurality of housing members 1010, 1020, and 1030. For example, the housing 1000 may be a structure formed by assembling a housing member 1010 that forms side, rear, and lower surfaces, a housing member 1020 that forms an upper surface, and a housing member 1030 that forms a front surface. The configuration and assembly structure of the housing 1000 illustrated in FIG. 1 may be exemplary and modified in various ways as needed.

The housing 1000 may include an opaque material. For example, at least a portion of the housing 1000 may include a metal material. At least a portion of the housing member 1030 that forms the front surface may include a metal material. At least an outer surface 1001 of the housing 1000 may include a metal material. For example, the housing 1000 may include a metal plate. For example, the housing 1000 may include a steel plate. However, the material of the housing 1000 is not limited thereto, and various materials may be selected considering the outer appearance, feel, and the like of the electronic device 1.

The housing 1000 may include an opening 1200 formed in the front surface, through which a portion of the touch screen panel 100 is exposed. The opening 1200 may be provided in the housing member 1030 that forms the front surface of the electronic device 1. The touch screen panel 100 may be exposed to the outside through the opening 1200.

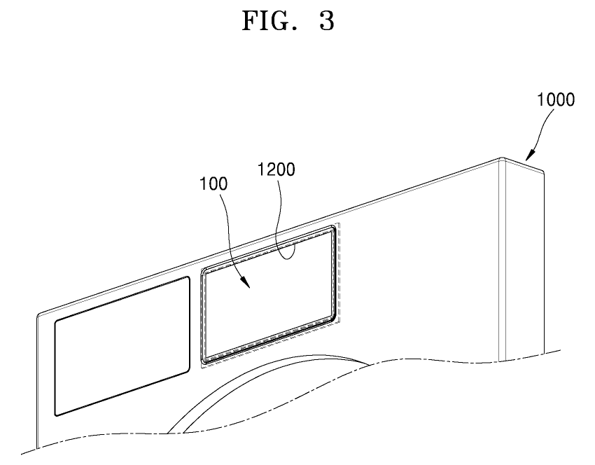

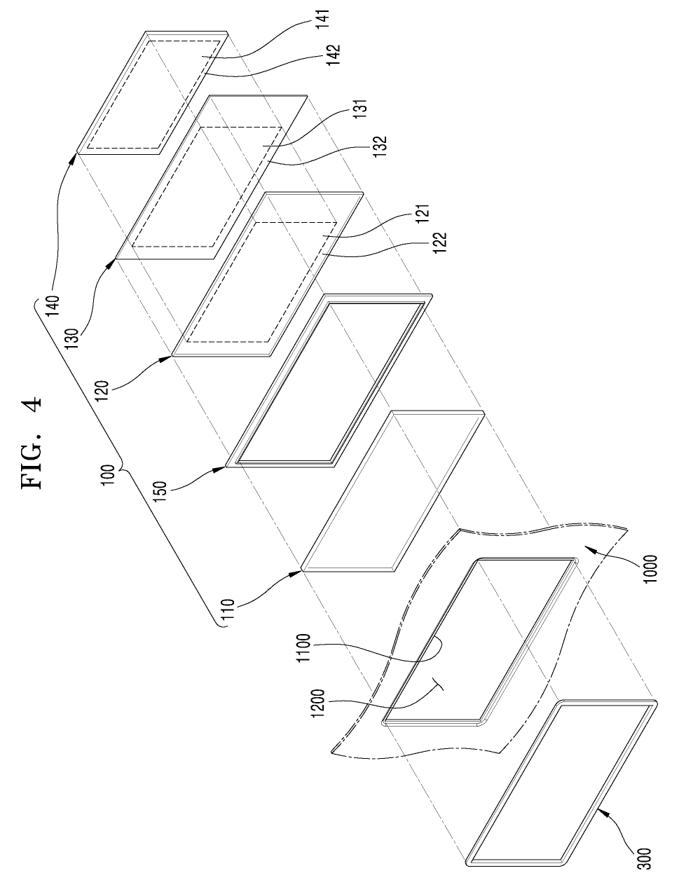

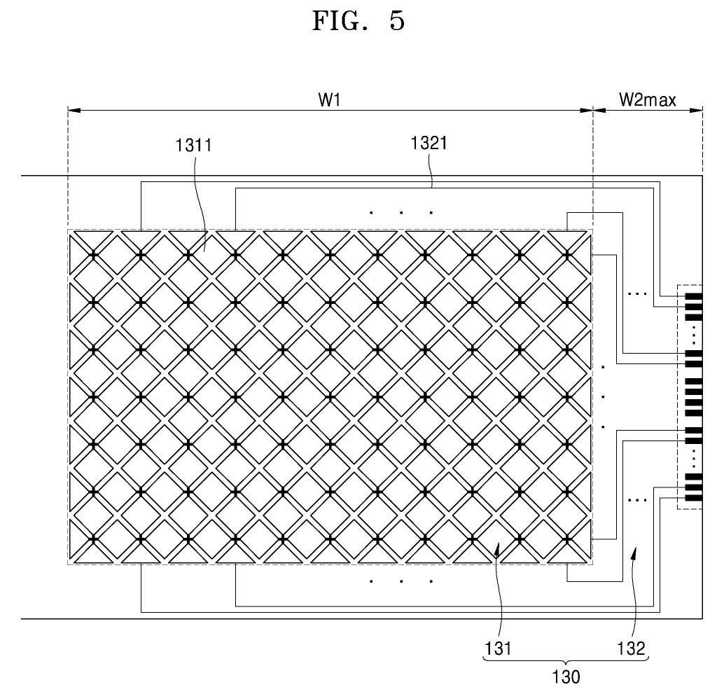

FIG. 3 is an assembly perspective view showing an example in which the touch screen panel 100 is located in the housing 1000 in the electronic device 1, according to an embodiment, and FIG. 4 is an exploded perspective view showing the touch screen panel 100 of FIG. 3 in an exploded state. FIG. 5 is a schematic diagram showing a touch panel 130 of the touch screen panel 100, according to an embodiment.

Referring to FIGS. 3 to 5, the touch screen panel 100 according to an embodiment may be located such that a portion of the touch screen panel 100 is exposed through the opening 1200 of the housing 1000. The touch screen panel 100 may include a first tempered glass 110, a second tempered glass 120, a touch panel 130, and a display panel 140 that are inserted into the opening 1200 of the housing 1000.

The touch panel 130 may be located at a front side of the display panel 140. In other words, the display panel 140 may be located at a rear side of the touch panel 130.

The touch panel 130 may include a touch area 131 that receives a touch input and a wiring area 132 located on an edge of the touch area 131. The touch panel 130 may be a capacitive touch panel 130.

The touch area 131 may include a plurality of touch electrodes 1311 that receive a touch input, as shown in FIG. 5. The plurality of touch electrodes 1311 may include a first touch electrode extending in a first direction and a second touch electrode extending in a second direction perpendicular to the first direction. An ITO electrode may be used as an example of the touch electrode 1311. However, the type of touch electrode 1311 is not limited thereto, and any material to be used as the touch electrode 1311 of the touch panel 130 may be modified in various ways.

A plurality of wires 1321 for transmitting electrical signals to the touch area 131 may be arranged in the wiring area 132. The number of wires 1321 may vary depending on the touch electrode 1311 located in the touch area 131. As the size of the touch area 131 increases, the number of touch electrodes 1311 located in the touch area 131 increases, and accordingly, the number of wires 1321 also increases. When the number of wires 1321 increases, the width of the wiring area 132 may increase. For example, a maximum width W2max of the wiring area 132 may be 10 mm or more. The maximum width W2max of the wiring area 132 may be 5 % or more of a width W1 of the touch area 131. The maximum width W2max of the wiring area 132 may be 50 mm or less. The maximum width W2max of the wiring area 132 may be 15 % or less of the width W1 of the touch area 131. Here, the maximum width W2max of the wiring area 132 may be defined as the width of the wiring area 132 having the largest width from among the wiring areas 132 arranged at upper, lower, left, and right sides of the touch area 131 when the widths of the wiring areas 132 arranged at edges of the touch area 131 are different, for example.

Referring back to FIG. 4, the display panel 140 may include a display area 141 and a non-display area 142 surrounding the display area 141. The display area 141 may be rectangular, but is not necessarily limited thereto. At least a portion of the display panel 140 may be exposed to the outside through the touch panel 130, the second tempered glass 120, and the first tempered glass 110.

The display panel 140 may be a liquid crystal display panel. For example, although not shown, the display panel 140 may include a first display substrate, a second display substrate, and a liquid crystal layer therebetween. A plurality of pixels (not shown) may be arranged in the display area 141. Each pixel may be arranged in a matrix form. A sealing member (not shown) may be located in the non-display area 142. However, the type of display panel 140 is not limited thereto and may be modified in various ways.

The first tempered glass 110 may be inserted into the opening 1200 of the housing 1000. The first tempered glass 110 may be located at a front side of the touch panel 130. The first tempered glass 110 may be located at a front side of the touch area 131 of the touch panel 130. The first tempered glass 110 may expose the touch area 131 of the touch panel 130 to the outside of the electronic device 1.

The first tempered glass 110 may have a smaller size than the touch panel 130. The first tempered glass 110 may have a shape corresponding to the touch area 131 of the touch panel 130. The first tempered glass 110 may have a size corresponding to the touch area 131 of the touch panel 130. For example, the size of the first tempered glass 110 may be the same as or slightly smaller than the size of the touch area 131. For example, a size difference between the first tempered glass 110 and the touch area 131 may be within several mm. For example, a size difference between the first tempered glass 110 and the touch area 131 may be within 3 mm. For example, a size difference between the first tempered glass 110 and the touch area 131 may be within 1 mm. The first tempered glass 110 may have a size corresponding to the touch area 131 of the touch panel 130.

The first tempered glass 110 may have a shape corresponding to the opening 1200. The first tempered glass 110 may have a size slightly smaller than the opening 1200. For example, the first tempered glass 110 may be smaller than the opening 1200, but a size difference between the first tempered glass 110 and the opening 1200 may be within several mm. For example, a size difference between the first tempered glass 110 and the opening 1200 may be within 10 mm, within 7 mm, or within 5 mm.

The second tempered glass 120 may be located between the touch panel 130 and the first tempered glass 110. The touch panel 130 may be located at a rear side of the second tempered glass 120.

The second tempered glass 120 may be configured to support the touch panel 130. The second tempered glass 120 may have a higher strength than the touch panel 130. The touch panel 130 and the second tempered glass 120 may be fixed by bonding. Although not shown, a transparent adhesive film (not shown) may be located between the touch panel 130 and the second tempered glass 120. As an example of a transparent adhesive film, optical clear adhesive (OCA) may be used, but is not necessarily limited thereto.

The second tempered glass 120 may have a larger size than the first tempered glass 110. The second tempered glass 120 may have a larger size than the opening 1200 of the housing 1000. The second tempered glass 120 may have a size corresponding to the touch panel 130. For example, the size of the second tempered glass 120 may be the same as or slightly smaller than the size of the touch panel 130. For example, a size difference between the second tempered glass 120 and the touch panel 130 may be within several mm. For example, a size difference between the second tempered glass 120 and the touch panel 130 may be within 3 mm. For example, a size difference between the second tempered glass 120 and the touch panel 130 may be within 1 mm.

The second tempered glass 120 may include a first support area 121 that is located between the touch area 131 of the touch panel 130 and the first tempered glass 110 and supports the touch area 131, and a second support area 122 that is located between the housing 1000 and the wiring area 132 and supports the wiring area 132. The touch area 131 may be fixed to the first support area 121 by adhesion. The wiring area 132 may be fixed to the second support area 122 by adhesion.

The second tempered glass 120 may be an insulator. The second tempered glass 120 may have lower conductivity than the material of the housing 1000. As the second tempered glass 120 is located between the housing 1000 and the touch panel 130, even if noise such as static electricity is introduced through the housing 1000, the noise may be prevented from being introduced to the touch panel 130.

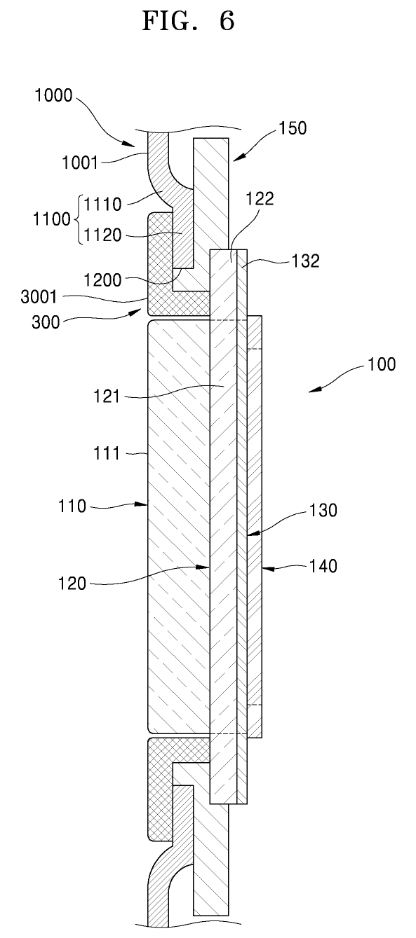

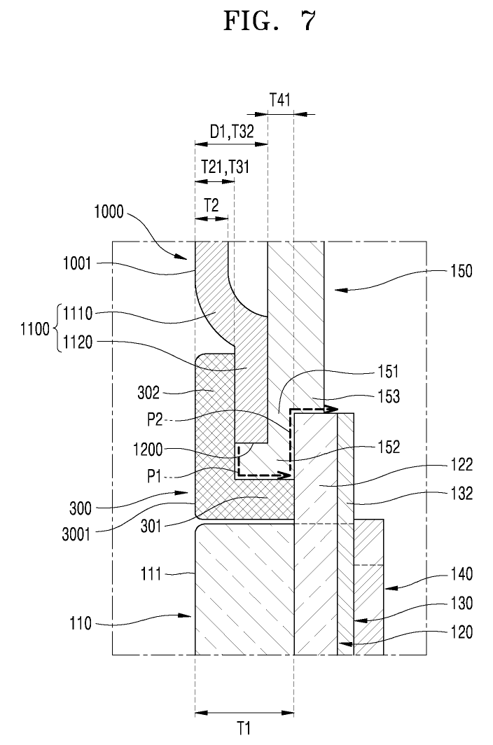

FIG. 6 is a cross-sectional view showing a state in which the touch screen panel 100 is located in the housing 1000, according to an embodiment, and FIG. 7 is an enlarged cross-sectional view showing a portion of the touch screen panel 100 of FIG. 6.

Referring to FIGS. 6 and 7, the first tempered glass 110 of the touch screen panel 100 is inserted into the opening 1200 of the housing 1000, the first support area 121 of the second tempered glass 120 is located at a rear side of the first tempered glass 110, and the second support area 122 is located at a rear side of the housing 1000. A portion of the second support area 122 of the second tempered glass 120 is located to face a rear surface of the housing 1000.

The touch area 131 of the touch panel 130 is exposed to the outside through the first support area 121 and the first tempered glass 110, and the wiring area 132 is covered by the housing 1000 and is not exposed to the outside. At least a portion of the display panel 140 may be exposed to the outside through the touch area 131, the first support area 121, and the first tempered glass 110.

The touch screen panel 100 according to an embodiment may further include a glass protection member 150 between the housing 1000 and the second tempered glass 120. The glass protection member 150 may be located between the housing 1000 and the second support area 122 of the second tempered glass 120.

The glass protection member 150 may have a structure extending along an edge of the second tempered glass 120. In other words, the glass protection member 150 may have a ring structure corresponding to an edge shape of the second tempered glass 120. The glass protection member 150 may have a continuous closed loop structure along the edge, but is not necessarily limited thereto. For example, the glass protection member 150 may have an open loop structure with some sections broken along the edge.

The glass protection member 150 may be disposed between the housing 1000 and the second tempered glass 120 to prevent contact between the housing 1000 and the second tempered glass 120. At least a portion of the glass protection member 150 may be located between the housing 1000 and the second support area 122 of the second tempered glass 120. Through the glass protection member 150, it is possible to prevent breakage of the second tempered glass 120 that may occur during a process in which the second tempered glass 120 comes into direct contact with the housing 1000.

For example, if the material of the housing 1000 is metal, a surface condition of the housing 1000 may be uneven, and in some cases, burrs may occur. If the second tempered glass 120 comes into contact with the housing 1000 having an uneven surface condition, the second tempered glass 120 may be damaged, and for example, the second tempered glass 120 may be scratched or broken.

In contrast, in the touch screen panel 100 according to an embodiment, contact between the housing 1000 and the second tempered glass 120 may be prevented through the glass protection member 150, thereby preventing breakage of the second tempered glass 120.

The glass protection member 150 may have a different material from the second tempered glass 120. For example, the glass protection member 150 may have a material that is less brittle than the second tempered glass 120. For example, the glass protection member 150 may have a material that is less breakable than the second tempered glass 120. For example, the glass protection member 150 may include a resin. For example, the glass protection member 150 may be, but is not necessarily limited to, acrylonitrile butadiene styrene (ABS) resin.

The glass protection member 150 may have a different material from the housing 1000. The glass protection member 150 may have a material having lower conductivity than the housing 1000. For example, when the housing 1000 includes steel, the glass protection member 150 may include resin. Accordingly, the glass protection member 150 may, together with the second tempered glass 120, perform a function of preventing noise such as static electricity introduced through the housing 1000 from being transmitted to the touch panel 130.

The glass protection member 150 may be an injection-molded product formed by injection molding. However, a manufacturing process of the glass protection member 150 is not necessarily limited thereto and may be manufactured in various ways depending on the material.

The glass protection member 150 may include a contact blocking area 151 located between the second tempered glass 120 and the housing 1000 and a housing insertion area 152 inserted into the opening 1200 of the housing 1000.

A front surface of the contact blocking area 151 may be in contact with a rear surface of the housing 1000 and a rear surface of the contact blocking area 151 may be in contact with a front surface of the second tempered glass 120.

The housing insertion area 152 may extend from the contact blocking area 151. The housing insertion area 152 may be folded from the contact blocking area 151. The housing insertion area 152 may protrude forward to be inserted into the opening 1200.

The housing insertion area 152 may be inserted into the opening 1200 of the housing 1000, through which the glass protection member 150 may be fixed in position in up and down directions perpendicular to front and rear directions with respect to the housing 1000. The housing insertion area 152 inserted into the opening 1200 may have an outer surface in contact with an inner surface defining the opening 1200 in the housing 1000.

The glass protection member 150 may further include an edge mounting area 153 provided to allow an edge of the second tempered glass 120 to be mounted. The edge mounting area 153 may be a groove structure corresponding to a shape of the edge of the second tempered glass 120. The edge of the second tempered glass 120 may be located in the edge mounting area 153 of the glass protection member 150, and the second tempered glass 120 may be fixed in up and down directions with respect to the glass protection member 150.

The touch screen panel 100 having the structure described above may be assembled from the rear side of the housing 1000 toward the front side. For example, the first tempered glass 110 of the touch screen panel 100 and the housing insertion area 152 of the glass protection member 150 may be inserted into the opening 1200 of the housing 1000.

The electronic device 1 may further include a gap blocking member 300 inserted into a gap between the first tempered glass 110 and the opening 1200.

The gap blocking member 300 may include a material different from the material of the housing 1000. The material of the gap blocking member 300 may be the same as the material of the glass protection member 150. The material of the gap blocking member 300 may include resin. For example, the gap blocking member 300 may be, but is not necessarily limited to, acrylonitrile butadiene styrene (ABS) resin.

The gap blocking member 300 may be an injection-molded product formed by injection molding. However, a manufacturing process of the gap blocking member 300 is not necessarily limited thereto and may be manufactured in various ways depending on the material.

The gap blocking member 300 may have a shape that is inserted into the opening 1200 of the housing 1000 toward a rear side. For example, a cross-sectional shape of the gap blocking member 300 may be L-shaped. The gap blocking member 300 may include an insertion area 301 inserted between the first tempered glass 110 and the opening 1200 and a cover area 302 that covers an end 1100 defining the opening 1200 in the housing 1000.

The insertion area 301 may be located between the outer surface of the first tempered glass 110 and the inner surface of the glass protection member 150. The cover area 302 may extend in up and down directions from the insertion area 301 and overlap the end 1100 of the housing 1000 in front and rear directions.

The end 1100 of the housing 1000 may be surrounded by the gap blocking member 300 and the glass protection member 150. For example, a front surface of the end 1100 of the housing 1000 may be in contact with the gap blocking member 300 and an inner surface and a rear surface of the end 1100 of the housing 1000 may be in contact with the glass protection member 150.

The gap blocking member 300 may have a material having lower conductivity than the housing 1000. For example, when the housing 1000 includes steel, the gap blocking member 300 may include resin. The glass protection member 150 may, together with the second tempered glass, perform a function of preventing noise such as static electricity introduced through the housing 1000 from being transmitted to the touch panel 130. For example, if the conductivity of the gap blocking member 300, the glass protection member 150, and the second tempered glass 120 is lower than that of the housing 1000, noise such as static electricity acting on the housing 1000 needs to pass through a first bypass path P1 between the gap blocking member 300 and the glass protection member 150 and a second bypass path P2 between the glass protection member 150 and the second tempered glass 120 to be transmitted to the touch panel 130. The sum of the length of the first bypass path P1 and the length of the second bypass path P2 may be 5 mm or more. As such, as a transmission path of noise acting on the housing 1000 increases, noise such as static electricity introduced into the housing 1000 may be prevented from being transmitted to the touch panel 130.

The housing 1000 may have the end 1100 defining the opening 1200. The end 1100 of the housing 1000 may include a metal plate that is at least partially bent.

The end 1100 of the housing 1000 may include a folded area 1110 and a flat area 1120 that extends from the folded area 1110 to provide a flat surface.

The folded area 1110 may be in a shape that is bent toward a rear side. The flat area 1120 may extend in up and down directions from the folded area 1110. The flat area 1120 may extend in a direction parallel to an outer surface 111 of the first tempered glass 110. The flat area 1120 may be surrounded by the gap blocking member 300 and the glass protection member 150. For example, an inner surface and a rear surface of the flat area 1120 may be surrounded by the glass protection member 150 and a front surface of the flat area 1120 may be surrounded by the gap blocking member 300.

The outer surface 1001 of the housing 1000 may be located on the same plane as the outer surface 111 of the first tempered glass 110. An outer surface 3001 of the gap blocking member 300 may be located on the same plane as the outer surface 111 of the first tempered glass 110. The outer surface 3001 of the gap blocking member 300 may be located on the same plane as the outer surface 1001 of the housing 1000.

A thickness T21 of the folded area 1110 of the housing 1000 in front and rear directions may correspond to a thickness T31 of the cover area 302 of the gap blocking member 300 in front and rear directions. A thickness T1 of the first tempered glass 110 in front and rear directions may correspond to a thickness T32 of the insertion area 301 of the gap blocking member 300 in front and rear directions.

The thickness T1 of the first tempered glass 110 in front and rear directions may be greater than a depth D1 of the opening 1200. The thickness T1 of the first tempered glass 110 in front and rear directions may correspond to the sum of the depth D1 of the opening 1200 and a thickness T41 of the contact blocking area 151 of the glass protection member 150.

Hereinafter, a process of inserting and fixing the touch screen panel 100 having the structure described above into the opening 1200 of the housing 1000 is described.

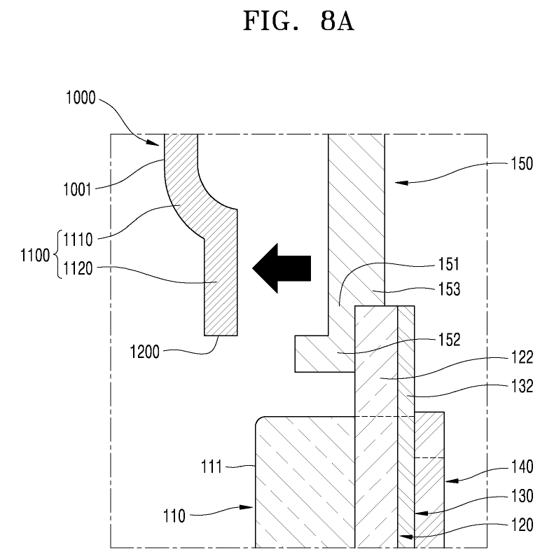

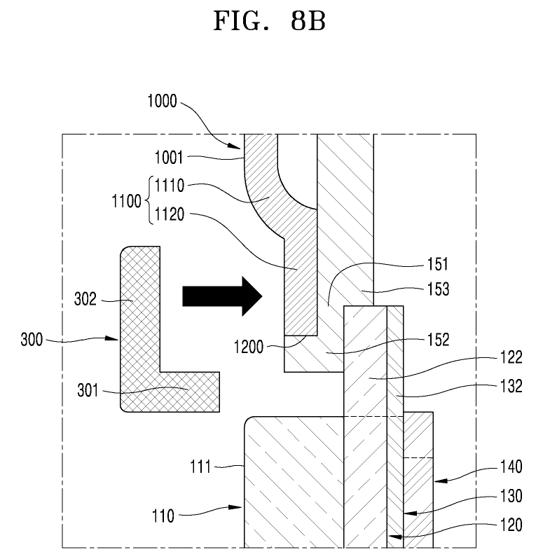

FIGS. 8A and 8B are diagrams for explaining a process of fixing the touch screen panel 100 to the housing 1000, according to an embodiment.

Referring to FIG. 8A, the touch screen panel 100 is configured such that the first tempered glass 110, the second tempered glass 120, the touch panel 130, and the display panel 140 are sequentially arranged, and the glass protection member 150 is located to surround at least a portion of the edge of the second tempered glass 120.

In this state, the touch screen panel 100 is located at a rear side of the housing 1000 and moved forward and a portion of the touch screen panel 100 is inserted into the opening 1200 of the housing 1000. The first tempered glass 110 of the touch screen panel 100 and the housing insertion area 152 of the glass protection member 150 are inserted into the opening 1200 of the housing 1000. During the insertion process, an outer surface of the housing insertion area 152 is in contact with an inner surface of the flat area 1120 of the housing 1000 and a front surface of the contact blocking area 151 is in contact with a rear surface of the flat area 1120 of the housing 1000. Accordingly, the touch screen panel 100 is fixed in position in up and down directions with respect to the housing 1000.

Referring to FIG. 8B, some components of the touch screen panel 100 are inserted into the opening 1200 of the housing 1000 such that the touch screen panel 100 is fixed in up and down directions with respect to the housing 1000, and the gap blocking member 300 is moved rearward while the gap blocking member 300 is located at a front side of the housing 1000. The insertion area 301 of the gap blocking member 300 is inserted between the first tempered glass 110 and the housing insertion area 152 of the glass protection member 150. The gap blocking member 300 may be assembled to the housing 1000 and the touch screen panel 100 such that an outer surface of the insertion area 301 is in contact with an inner surface of the housing insertion area 152 and a rear surface of the cover area 302 is in contact with a front surface of the flat area 1120 of the housing 1000 and a front surface of the housing insertion area 152.

By the structure described above, the touch screen panel 100 may be fixed at a position corresponding to the opening 1200 of the housing 1000. As such, the touch screen panel 100 may be easily replaced or repaired because the touch screen panel 100 is fixed to the housing 1000 without using a separate adhesive material or the like.

In the electronic device 1 of the embodiment described above, the structure in which the outer surface 1001 of the housing 1000 and the outer surface 111 of the first tempered glass 110 of the touch screen panel 100 are arranged to be aligned with each other has been described. However, the electronic device 1 according to an embodiment is not necessarily limited thereto and may vary. The housing 1000 according to an embodiment has been described in terms of the structure in which the end 1100 defining the opening 1200 has the folded area 1110 and the flat area 1120. However, the structure of the end 1100 of the housing 1000 is not limited thereto and may vary.

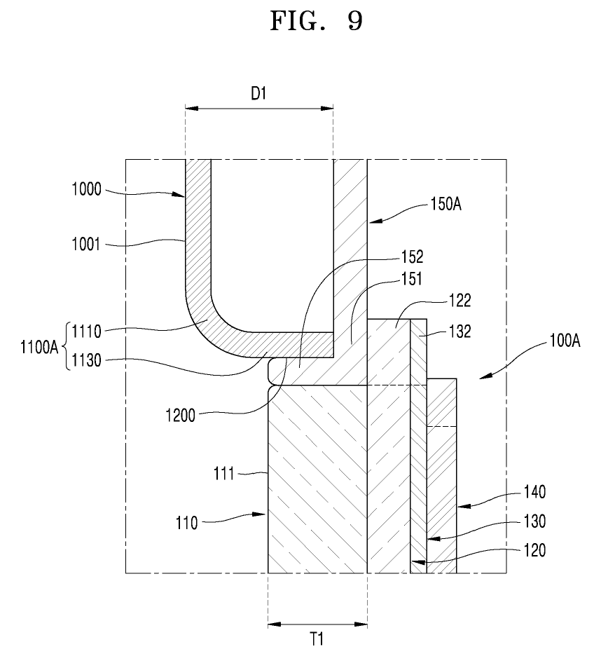

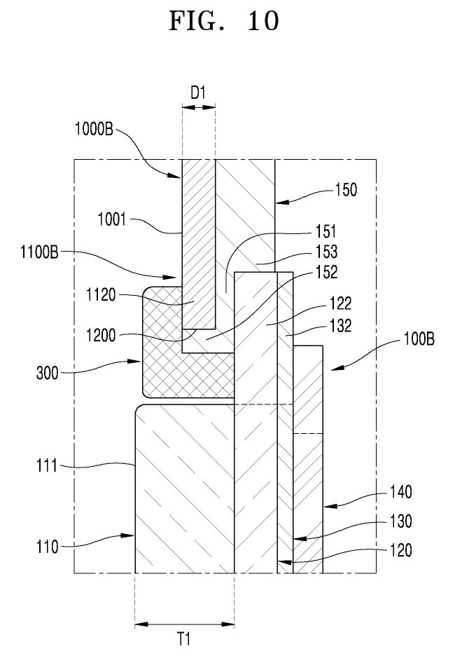

FIG. 9 is a cross-sectional view illustrating another example of the housing 1000 and the touch screen panel 100 in the electronic device 1, according to an embodiment. FIG. 10 is a cross-sectional view illustrating another example of the housing 1000 and the touch screen panel 100 in the electronic device 1, according to an embodiment.

Referring to FIG. 9, the electronic device 1 according to an embodiment includes the housing 1000 having the opening 1200 and a touch screen panel 100A.

An end 1100A defining the opening 1200 in the housing 1000 according to an embodiment includes the folded area 1110 and a fixed area 1130 extending in front and rear directions from the folded area 1110. A glass protection member 150A of the touch screen panel 100A may be assembled in the fixed area 1130.

The touch screen panel 100A may be configured such that the first tempered glass 110, the second tempered glass 120, the touch panel 130, and the display panel 140 are sequentially arranged in front and rear directions, and the glass protection member 150A is located to surround the edge of the second tempered glass 120. The glass protection member 150A may have a structure that is in contact with a front surface of the touch area 131 of the touch panel 130 and is not in contact with an outer surface of the touch area 131.

The glass protection member 150A may include the contact blocking area 151 between the second tempered glass 120 and the housing 1000 and the housing insertion area 152 inserted into the opening 1200 of the housing 1000. The housing insertion area 152 may be inserted into the opening 1200 of the housing 1000 such that an outer surface of the housing insertion area 152 is in contact with an inner surface of the fixed area 1130.

The outer surface 1001 of the housing 1000 and the outer surface 111 of the first tempered glass 110 may not be aligned with each other. The outer surface 1001 of the first tempered glass 110 may be located further rearward than the outer surface 111 of the housing 1000. For example, the depth D1 of the opening 1200 may be greater than the thickness T1 of the first tempered glass 110 in front and rear directions.

Referring to FIG. 10, the electronic device 1 according to an embodiment includes the housing 1000B having the opening 1200 and a touch screen panel 100B.

The touch screen panel 100B may be configured such that the first tempered glass 110, the second tempered glass 120, the touch panel 130, and the display panel 140 are sequentially arranged in front and rear directions, and the glass protection member 150 is located to surround the edge of the second tempered glass 120.

In the housing 1000B, an end 1100B defining the opening 1200 may include the flat area 1120 extending in up and down directions. The end 1100B of the housing 1000 may not include the folded area 1110 that is bent rearward.

The outer surface 1001 of the housing 1000B and the outer surface 111 of the first tempered glass 110 may not be aligned with each other. The outer surface 111 of the first tempered glass 110 may be located further forward than the outer surface 1001 of the housing 1000. For example, the depth D1 of the opening 1200 may be less than the thickness T1 of the first tempered glass 110 in front and rear directions.

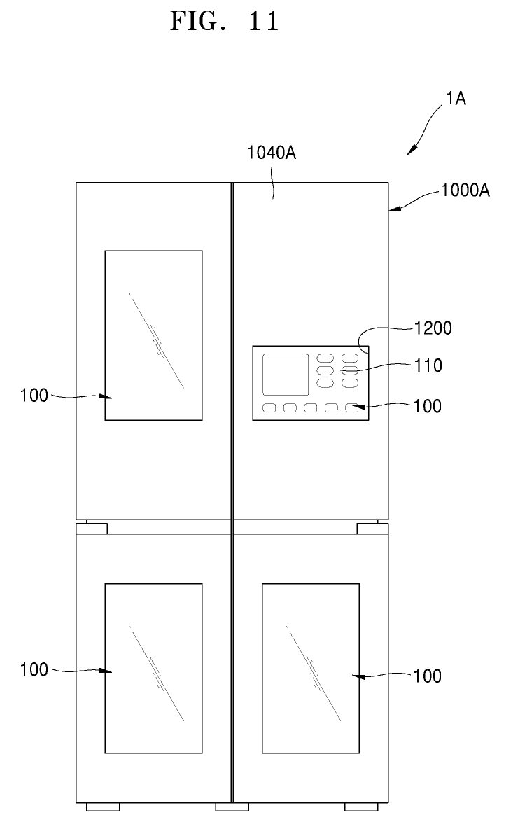

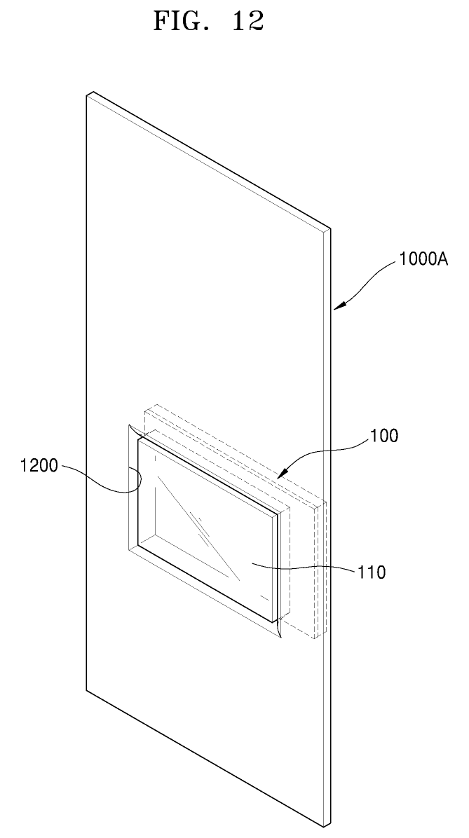

In the embodiments described above, a laundry treatment device is used as an example of the electronic device 1. However, the electronic device 1 according to an embodiment may be a device other than a laundry treatment device. For example, as shown in FIGS. 11 and 12, an electronic device 1A according to an embodiment may be a refrigerator. The touch screen panel 100 may be located on a door 1040A provided in a housing 1000A of the electronic device 1A.

In the embodiments described above, the touch screen panel 100 has been described in terms of the structure in which the second tempered glass 120 is located at a front side of the touch panel 130 and the touch screen panel 100 further includes the glass protection member 150 for preventing breakage of the second tempered glass 120. However, the structure of the touch screen panel 100 is not necessarily limited thereto, and depending on the arrangement of the second tempered glass 120, the glass protection member 150 may be omitted.

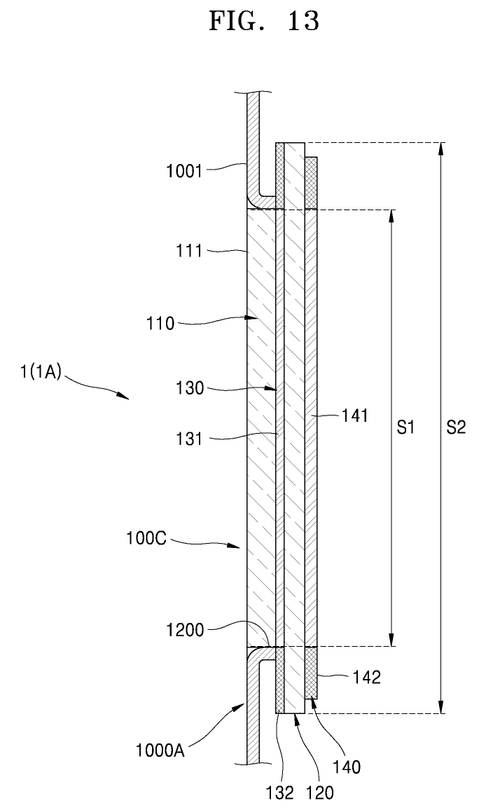

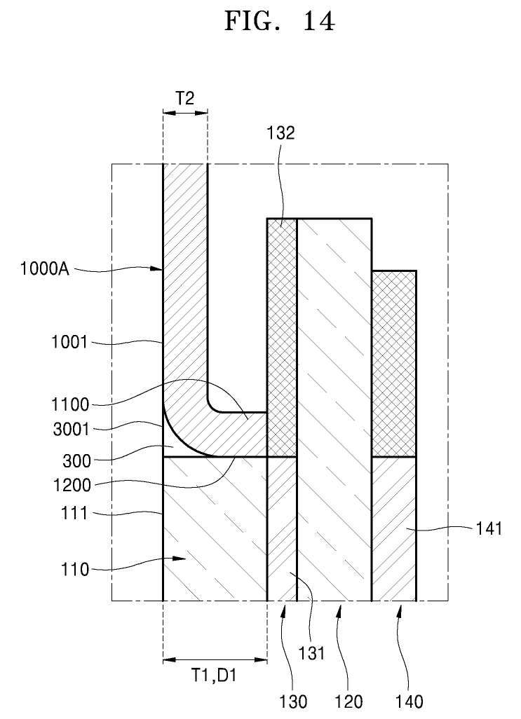

FIG. 13 shows an example of a structure in which a touch screen panel 100C is located in the housing 1000A according to an embodiment, and FIG. 14 is an enlarged view of a portion of the touch screen panel 100C and the housing 1000A of FIG. 13.

Referring to FIGS. 13 and 14, the electronic device 1 according to an embodiment may include the housing 1000A, the touch screen panel 100C, and the gap blocking member 300.

The touch screen panel 100C may include the first tempered glass 110, the touch panel 130, the second tempered glass 120, and the display panel 140 that are arranged sequentially. The second tempered glass 120 may be located at a rear side of the touch panel 130. The second tempered glass 120 may be located between the touch panel 130 and the display panel 140.

A size S1 of the first tempered glass 110 may be the same as the size of the opening 1200. The height of the first tempered glass 110 may be the same as the height of the opening 1200.

The size S1 of the first tempered glass 110 may be less than a size S2 of the touch panel 130. In other words, the size S2 of the touch panel 130 may be greater than the size S1 of the first tempered glass 110. For example, the height of the first tempered glass 110 may be less than the height of the touch panel 130. In other words, the height of the touch panel 130 may be greater than the height of the first tempered glass 110.

The first tempered glass 110 may have a size corresponding to the touch area 131 of the touch panel 130. For example, the size S1 of the first tempered glass 110 may be the same as or slightly smaller than the size of the touch area 131. For example, a size difference between the first tempered glass 110 and the touch area 131 may be within several mm. For example, a size difference between the first tempered glass 110 and the touch area 131 may be within 3 mm. For example, a size difference between the first tempered glass 110 and the touch area 131 may be within 1 mm.

The touch panel 130 may be located at a rear side of the housing 1000. The size of the touch panel 130 may be greater than the size of the opening 1200. The touch panel 130 may be located such that the touch area 131 overlaps the opening 1200 and the wiring area 132 overlaps the housing 1000.

As the wiring area 132 is located to overlap the housing 1000, the touch area 131 of the touch panel 130 may be viewed externally through the opening 1200, while the wiring area 132 of the touch panel 130 may be prevented from being viewed externally. Accordingly, a bezel that does not receive a touch input from the touch panel 130 may be prevented from being exposed to the outside.

As the first tempered glass 110 is located at a front side of the touch panel 130, the outer surface 1001 of the touch screen panel 100C may be aligned with the outer surface 1001 of the housing 1000.

The housing 1000A may have the end 1100 that is bent to define the opening 1200. The depth D1 of the opening 1200 may be greater than a thickness T2 of the housing 1000A itself.

The first tempered glass 110 may be located within the opening 1200 such that an outer surface 1401 of the first tempered glass 110 is aligned with the outer surface 1001 of the housing 1000. For example, the thickness T1 of the first tempered glass 110 may correspond to the depth D1 of the opening 1200. For example, the thickness T1 of the first tempered glass 110 may be the same as the depth D1 of the opening 1200. The thickness T1 of the first tempered glass 110 may be greater than the thickness of the second tempered glass 120. The thickness T1 of the first tempered glass 110 may be greater than the thickness T2 of the housing 1000 itself. The thickness T1 of the first tempered glass 110 may be 2 mm or more. The thickness T1 of the first tempered glass 110 may be 5 mm or less in consideration of reception of a touch input of the touch panel 130 located at a rear side of the first tempered glass 110.

As such, the outer surface 1401 of the first tempered glass 110 of the touch screen panel 100C is located on the same plane as the outer surface 1001 of the housing 1000, and thus the electronic device 1 may have a smooth outer appearance.

The gap blocking member 300 may be located between the housing 1000 and the first tempered glass 110. The gap blocking member 300 may perform a function of filling the gap between the opening 1200 of the housing 1000 and the first tempered glass 110. The gap blocking member 300 may be an injection-molded product containing resin. The outer surface 3001 of the gap blocking member 300 may be aligned with the outer surface 1401 of the first tempered glass 110 and the outer surface 1001 of the housing 1000.

For understanding the disclosure, reference numerals have been given to preferred embodiments illustrated in the drawings, and specific terms have been used to describe the embodiments, but the disclosure is not limited by the specific terms, and the disclosure may include all components that may be commonly conceived by those of skill in the art.

The specific implementations described in the disclosure are merely examples and do not limit the scope of the disclosure in any way. For the sake of brevity of the specification, descriptions of the existing electronic components, control systems, software, and other functional aspects of the systems may be omitted. Connections or connection members of lines between components illustrated in the drawings are merely illustrative of functional connections and/or physical or circuit connections, and may be represented as various functional connections, physical connections, or circuit connections that may be replaced or added in an actual device. When there is no specific mention of "required," "important," and the like, it may not be a required component for the application of the disclosure. The expressions "including," “comprising,” and the like used herein are intended to be understood as terms of the open-ended nature of the description.

The use of the term "the" and similar referential terms in the specification of the disclosure (especially in the claims) may refer to both the singular and the plural. When a range is described in the disclosure, it is considered to include the disclosure that applies separate values belonging to the range (unless otherwise stated), and is the same as describing each separate value constituting the range in the detailed description of the disclosure. Finally, unless there is an explicit description of the order or contrary description for operations constituting a method according to the present disclosure, the operations may be performed in any suitable order. The present disclosure is not necessarily limited to the order in which the operations are described. The use of any examples or exemplary terms ("e.g." or "and the like") in the present disclosure is merely intended to illustrate the present disclosure in more detail and is not intended to limit the scope of the present disclosure by such examples or exemplary terms, unless otherwise limited by the claims. Those of skill in the art to which the art belongs may clearly understand that various modifications and changes may be easily made without departing from the scope and spirit of the disclosure.

According to an embodiment, provided may be an electronic device having a touch screen panel in which only a touch area of a touch panel is selectively exposed through an opening in a housing.

According to an embodiment, provided may be an electronic device having a smooth outer appearance by locating an outer surface of a first tempered glass of a touch screen panel located in an opening of a housing and an outer surface of the housing on the same plane.

The electronic device according to an embodiment may include a touch screen panel and a housing that forms an outer appearance and having an opening on a front surface, through which a portion of the touch screen panel is exposed.

The touch screen panel may include a first tempered glass inserted into the opening, a touch panel including a touch area located at a rear side of the first tempered glass, exposed to a front side of the first tempered glass through the opening, and configured to receive a touch input, and a wiring area located at a rear side of the housing and surrounding the touch area, a second tempered glass including a first support area located between the touch area and the first tempered glass and supporting the touch area, and a second support area located between the housing and the wiring area and supporting the wiring area, a glass protection member having at least a portion located between the housing and the second support area and including a material different from the second tempered glass; and a display panel located at a rear side of the touch panel.

The second tempered glass may have a larger size than the first tempered glass.

The first tempered glass may have a smaller size than the touch panel, and the second tempered glass may have a size corresponding to the touch panel.

An outer surface of the first tempered glass may be located on the same plane as an outer surface of the housing.

The glass protection member may include a contact blocking area located between the second tempered glass and the housing and blocking contact between the second tempered glass and the housing, and a housing insertion area extending from the contact blocking area and protruding forward to be inserted into the opening of the housing.

The glass protection member may further include an edge mounting area provided to allow an edge of the second tempered glass to be mounted.

A material of the glass protection member may be different from a material of the housing.

The glass protection member may have a material having lower conductivity than the housing.

The electronic device may include a gap blocking member inserted into a gap between the first reinforced glass and the housing.

A front surface of an end defining the opening in the housing may be in contact with the gap blocking member and an inner surface and rear surface of the end may be in contact with the glass protection member such that the end is surrounded by the gap blocking member and the glass protection member.

The gap blocking member may have a material having lower conductivity than the housing.

An outer surface of the gap blocking member may be located on a same plane as an outer surface of the first tempered glass and an outer surface of the housing.

The housing may have an end defining the opening and the end may include a metal plate that is at least partially bent.

The end may include a folded area that is bent rearward, and a flat area that extends from the folded area and provides a flat surface.

The electronic device may include a washing machine.

The washing machine may include a tub fixedly installed inside the housing, a drum located rotatably inside the tub, a motor configured to transmit rotational power to the drum to rotate the drum, a water supply device connected to the tub to supply washing water into the tub, and a drainage device connected to the tub to discharge washing water inside the tub.

In the electronic device according to an embodiment, only the touch area of the touch panel may be selectively exposed through the opening in the housing.

The electronic device according to an embodiment may provide a smooth outer appearance to a user by locating the outer surface of the first tempered glass of the touch screen panel located in the opening of the housing and the outer surface of the housing on the same plane.

1. An electronic device comprising:
a touch screen panel; and
a housing that forms an outer appearance and includes an opening formed in a front surface, through which a portion of the touch screen panel is exposed,
wherein the touch screen panel comprises:
a first tempered glass insertable into the opening;
a touch panel, configured to receive a touch input, including a touch area located at a rear side of the first tempered glass that is exposed to a front side of the first tempered glass through the opening while thefirst tempered glass is inserted into the opening, and a wiring area located at a rear side of the housing and surrounding the touch area;
a second tempered glass including a first support area located between the touch area and the first tempered glass and supporting the touch area, and a second support area located between the housing and the wiring area and supporting the wiring area;
a glass protection member having at least a portion located between the housing and the second support area and including a material different from the second tempered glass; and
a display panel located at a rear side of the touch panel.

2. The electronic device of claim 1, wherein the second tempered glass has a size larger than a size of the first tempered glass.

3. The electronic device of claim 1, wherein the first tempered glass has a size smaller than a size of the touch panel, and
the second tempered glass has a size corresponding to the touch panel.

4. The electronic device of claim 1, wherein an outer surface of the first tempered glass is located on a same plane as an outer surface of the housing.

5. The electronic device of claim 1, wherein the glass protection member comprises:
a contact blocking area located between the second tempered glass and the housing and blocking contact between the second tempered glass and the housing; and
a housing insertion area extending from the contact blocking area and protruding forward to be inserted into the opening of the housing.

6. The electronic device of claim 5, wherein the glass protection member further includes:
an edge mounting area provided to allow an edge of the second tempered glass to be mounted.

7. The electronic device of claim 1, wherein a material of the glass protection member is different from a material of the housing.

8. The electronic device of claim 1, wherein the glass protection member has a material having lower conductivity than the housing.

9. The electronic device of claim 1, further comprising:
a gap blocking member insertable into a gap between the first tempered glass and the housing.

10. The electronic device of claim 9, wherein a front surface of an end defining the opening in the housing is in contact with the gap blocking member and an inner surface and rear surface of the end is in contact with the glass protection member such that the end is surrounded by the gap blocking member and the glass protection member.

11. The electronic device of claim 9, wherein the gap blocking member has a material having lower conductivity than the housing.

12. The electronic device of claim 9, wherein an outer surface of the gap blocking member is located on a same plane as an outer surface of the first tempered glass and an outer surface of the housing.

13. The electronic device of claim 1, wherein the housing has an end defining the opening, and
the end includes a metal plate that is at least partially bent.

14. The electronic device of claim 13, wherein the end includes a folded area that is bent rearward, and a flat area that extends from the folded area and provides a flat surface.

15. The electronic device of claim 1, wherein the electronic device is comprised in a washing machine, and
the washing machine comprises:
a tub arrangeable inside the housing;
a drum rotatable while inside the tub;
a motor configured to transmit rotational power to the drum to rotate the drum;
a water supply device to be connected to the tub to supply water into the tub; and
a drainage device to be connected to the tub to discharge the water from the tub.
